(19) United States
(12) Patent Application Publication
(10) Pub. No.: US 2010/0253006 A1
(43) Pub. Date: Oct. 7, 2010

(54) STEEL PRODUCTS FOR PISTON RINGS AND PISTON RINGS

(75) Inventors: Yoshiki Ishikawa, Tochigi (JP); Seisuke Takaki, Tochigi (JP); Motonobu Onoda, Tochigi (JP)

Correspondence Address: YOUNG & THOMPSON, 209 Madison Street, Suite 500, Alexandria, VA, 22314, US

(73) Assignee: NIPPON PISTON RING CO., LTD, Saitama-shi, Saitama (JP)

(21) Appl. No.: 12/744,411

(22) PCT Filed: Nov. 28, 2008
(86) PCT No.: PCT/JP2008/071680

§ 371 Date: Jun. 2, 2010

(30) Foreign Application Priority Data
Nov. 30, 2007 (JP) 2007-311188

(51) Int. Cl. F16J 9/26; F02F 5/00; C22C 38/00; C22C 38/18; C22C 38/58; C22C 38/04; C22C 38/08; C22C 38/38; C22C 38/16

(52) U.S. Cl. 277/443; 277/434; 277/442; 420/9; 420/34; 420/56; 420/65; 420/72; 420/73; 420/74; 420/76; 420/89; 420/119; 420/120; 420/94

(57) ABSTRACT

A steel product having a composition which contains by mass C: 0.01 to 1.9%, Si: 0.01 to 1.9%, Mn: 5.0 to 24.0% with balance consisting of Fe and unavoidable impurities and a steel product described above which further contains Cr: 18.0% or below and/or Ni: 12.0% or below in addition to the above essential elements. The above steel products may each further contain Al: 1% or below and/or N: 0.3% or below and the above steel products may each further contain one or more elements selected from among Nb, Ti, Zr, Mo and Cu in a total amount of 4.0% or below. The steel products can sufficiently follow the thermal expansion of a cylinder made of an aluminum alloy and thus enables the production of a piston ring which is suitable for use as a piston ring to slide on the inner face of a cylinder bore made of an aluminum alloy in an internal combustion engine and which can retain excellent sealing properties.

### TECHNICAL FIELD

The present invention relates to piston rings for internal combustion engines, and specifically to steel products suitable for making piston rings for aluminum alloy cylinders.

### BACKGROUND ART

In recent years, from the standpoint of global environment protection, weight reduction of automobile bodies is required. In automobile internal combustion engines, for the purpose of weight reduction, iron-based cylinder blocks are increasingly replaced by aluminum alloy cylinder blocks. In order to increase wear resistance, known piston rings sliding on the inside surface of cylinder bores of cylinder blocks of this type are made of iron-based materials such as martensitic stainless steel, and the surface of the piston rings optionally are treated by nitriding, chrome plating, or composite plating. However, since aluminium alloys have far greater thermal expansion coefficients than iron-based materials, piston rings made of iron-based materials cannot conform to the thermal expansion of aluminum alloy cylinders, thus causing the deterioration of the gas sealing property, which is an essential function of piston rings.

In order to solve the above-described problem, for example, Japanese Utility Model Application Laid-Open No. 63-64350 proposes an internal combustion engine which has an aluminum alloy cylinder block and piston rings made of austenitic stainless steel. In JP-U No. 63-64350, JIS SUS 304 steel is used as an example of austenitic stainless steel. Japanese Patent Application Laid-Open No. 2000-145963 proposes piston rings sliding on aluminum alloy cylinders as an opposite material, the piston rings being made of austenitic stainless steel having a thermal expansion coefficient of 15×10⁻⁶/° C. or higher, and preferably containing 3.5 to 17% of Ni and 15 to 20% of Cr.

In addition, though not limited for the use in aluminum alloy cylinders, for example, Japanese Patent Application Laid-Open No. 2005-345134 proposes a wire for piston rings, which has a precipitation hardening type semi-austenitic composition containing 6.50 to 8.50% of Ni, 16.00 to 18.00% of Cr, and 0.75 to 1.50% of Al. The technique described in JP-A No. 2005-345134 provides a wire for piston rings, which has resistant to dimensional change of the diameter of piston rings during heat treatment after coiling.

### DISCLOSURE OF INVENTION

However, the techniques described in JP-U No. 63-64350 and JP-A No. 2000-145963 require the contains of large amounts of costly Ni and further Cr, which results in increases in cost of piston rings, and presents a problem of economy. The austenitic stainless steel for making piston rings described in JP-U No. 63-64350 and JP-A No. 2000-145963 shows a tendency to decrease in the thermal expansion coefficient during forming into piston rings, so it is difficult to ensure having the intended thermal expansion coefficients. The technique described in JP-A No. 2005-345134 cannot ensure to have the sustainable achievement of intended thermal expansion coefficients conformable to the thermal expansion of aluminum alloy cylinders, and has a problem of economy because it requires the addition of a large amount of costly Ni.

The present invention is intended to provide low-cost steel products for piston rings and piston rings made of the steel products, wherein the steel products advantageously resolve the problems with prior art, and give an improved sealing property suitable for the use as piston rings sliding on the inside surface of the aluminum alloy cylinder bores of internal combustion engines.

In order to achieve the above-described object, the inventors diligently studied various factors affecting the sealing property of piston rings, with emphasis on the thermal expansion coefficient of the steel products for piston rings. As a result of this, they presumed that the above-described object can be achieved by the combination of appropriate contents of C and Mn, and has found that steel products containing C and Mn at higher amounts than prior art give a thermal expansion coefficient of 14.0×10⁻⁶/° C. or higher on average in a temperature range from room temperature to 200° C., which is close to that of aluminium alloys.

The present invention has been accomplished based on the above-described findings and additional further studies. The scope of the present invention is described below.

(1) A steel product for piston rings sliding on the inside surface of aluminum alloy cylinder bores, wherein the steel product for internal combustion engine piston rings comprises 0.01 to 1.9% of C, 0.01 to 1.9% of Si, and 5.0 to 24.0% of Mn in terms of mass, the remainder being composed of Fe and unavoidable impurities.

(2) According to (1), the steel product for internal combustion engine piston rings further includes 18.0% or less of Cr and/or 12.0% or less of Ni in terms of mass.

(3) According to (1) or (2), the steel product for internal combustion engine piston rings further includes 1% or less of Al in terms of mass.

(4) According to any one of (1) to (3), the steel product for internal combustion engine piston rings further includes 0.3% or less of N in terms of mass.

(5) According to any one of (1) to (4), the steel product for internal combustion engine piston rings further includes one or more elements selected from the group consisting of Nb, Ti, Zr, Mo, and Cu in the total amounts of 4.0% or less in terms of mass.

(6) Piston rings used in an internal combustion engine having an aluminum alloy cylinder block, where of the internal combustion engine piston rings are made of the steel product for piston rings according to any one of (1) to (5).

(7) According to (6), the internal combustion engine piston rings have a surface treating layer on the all surfaces or the outer peripheral surface of the piston rings.

(8) According to (7), the internal combustion engine piston rings, wherein the surface treating layer has a Vickers hardness of 700 to 1400 HV.

(9) According to (7) or (8), the internal combustion engine piston rings, wherein the surface treating layer is a nitride layer.

(10) According to any one of (7) to (9), the internal combustion engine piston rings include a diamond-like carbon film on the outer peripheral sliding surface of the surface treating layer.

### BRIEF DESCRIPTION OF THE DRAWINGS

FIG. 1 schematically illustrates the wear testing machine used for the examples.

### BEST MODE FOR CARRYING OUT THE INVENTION

The steel products for piston rings of the present invention are used in internal combustion engines having aluminum alloy cylinder blocks, and are suitable for manufacturing piston rings sliding on the inside of aluminum alloy cylinder bores. The steel products for piston rings of the present invention have an average thermal expansion coefficient of 14.0×10⁻⁶/° C. or higher in the temperature range from room temperature to 200° C. The compositions of the steel products for piston rings of the present invention are described below. Unless otherwise noted, % by mass is expressed simply as %.
C: 0.01 to 1.9%

C is an important element in the present invention.

C contributes to the strengthening of the steel products, and its coexistence with Mn markedly stabilizes the austenite phase thereby increasing the thermal expansion coefficient of the steel products. These effects are markedly achieved when the amount of C is 0.01% or more. However, if the amount of C is more than 1.9%, carbides and graphite are markedly formed to deteriorate ductility, which results in the deterioration of cold-workability and productivity. Accordingly, the amount of C is from 0.01% to 1.9%, preferably 0.03% or more, more preferably from 0.03 to 1.5%, and even more preferably from 0.05 to 1.2%.
Si: 0.01 to 1.9%

Si acts as a deoxidizer for molten steel to improve the castability of the molten steel, and contributes to the strengthening of the steel products. In order to ensure hot workability, the amount of Si is preferably 0.01% or more. On the other hand, if the amount of Si exceeds 1.9%, the effect of Si on the improvement of castability is saturated, and ferrite is generated. Accordingly, the amount of Si is from 0.01 to 1.9%, preferably from 0.2 to 1.2%.
Mn: 5.0 to 24.0%

Mn is an important element in the present invention. Mn contributes to the strengthening of the steel products, and its coexistence with a proper amount of C markedly stabilizes the austenite phase thereby increasing the thermal expansion coefficient of the steel products. These effects are achieved when the amount of Mn is 5.0% or more. If the amount of Mn is less than 5.0%, the austenite phase is unstable, and the increase of the thermal expansion coefficient is not recognized. On the other hand, if the amount of Mn exceeds 24.0%, austenite grains are coarsened. Accordingly, the amount of Mn is from 5.0 to 24.0%, preferably from 7.0 to 22.0%, and even more preferably from 7 to 19%.

In the present invention, in addition to the above-described basic compositions, as necessary, 18.0% or less of Cr and/or 12.0% or less of Ni may be further contained.
Cr: 18.0% or less

Cr contributes to the strengthening of the steel products, improvement of corrosion resistance, and improvement of surface treatment properties. In the present invention, Cr may be contained as necessary. Specifically, when a nitride layer is formed on the surface of a piston ring, Cr effectively contributes to the improvement of surface treatment properties, particularly the improvement of the adhesion property of the surface treating layer. These effects are achieved when the amount of Cr is 0.01% or more. However, if the amount of Cr exceeds 18.0%, carbides and σ phases are markedly formed, which results in the deterioration of corrosion resistance and workability. Accordingly, the amount of Cr is preferably 18.0% or less, more preferably from 2.0 to 15.0%, and even more preferably from 5.0 to 15.0%.
Ni: 12.0% or less

Ni is an element which strongly stabilizes austenite, and may be contained as necessary. The effect is achieved when the amount of Ni is 0.01% or more. However, if the amount of Ni exceeds 12.0%, the effect of Ni on the stabilization of austenite phase is saturated and cannot be expected the effect corresponding to the containing amounts, which is not preferred in an economical viewpoint. Accordingly, the amount of Ni is preferably 12.0% or less, and more preferably from 0.01 to 8.0%.

In the present invention, in addition to the above-described compositions, Al may be added as necessary in the amount of 1% or less.
Al: 1% or less

Al acts as a deoxidizer for molten steel, and contributes to grain refining in the steel products. As necessary, Al is contained preferably in the amount of 0.05% or more. On the other hand, if the amount of Al is more than 1%, inclusions tend to increase, which results in the deterioration of ductility and frequent occurrence of internal defects. Accordingly, the amount of Al is preferably 1% or less.

In the present invention, in addition to the above-described compositions, N may be added as necessary in the amount of 0.3% or less.
N: 0.3% or less

N contributes to the strengthening of the steel products in the same manner as C. In addition, N stabilizes the austenite phase, and increases the thermal expansion coefficient of the steel products. These effects are markedly achieved when the amount of N is 0.01% or more. However, if the amount of N exceeds 0.3%, the effect of N on the stabilization of the austenite phase is saturated, and internal defects such as pinholes frequently occur. Accordingly, the amount of N is preferably 0.3% or less, and more preferably from 0.1 to 0.2%.

In the present invention, in addition to the above-described compositions, one or more elements selected from the group consisting of Nb, Ti, Zr, Mo, and Cu may be added as necessary.

One or more elements selected from the group consisting of Nb, Ti, Zr, Mo, and Cu: 4.0% or less in total

Nb, Ti, Zr, Mo, and Cu refine the microstructure of the steel products thereby contributing the improvement of high temperature strength, and one or more elements selected from them may be contained as necessary. Their effects are markedly achieved when they are contained in the total amount of 0.05% or more. On the other hand, if the total amount exceeds 4.0%, toughness deteriorates. Accordingly, the total amount of one or more elements selected from Nb, Ti, Zr, Mo, and Cu is preferably 4.0% or less, and more preferably from 0.01 to 2.0%.

The remainder other than the above-described elements is composed of Fe and unavoidable impurities. The unavoidable impurities may contain 0.06% or less of P and 0.05% or less of S.
P: 0.06% or less

If P is present in a high contents, it strengthens the steel products to deteriorate the ductility and toughness, which results in the deterioration of the workability of the steel products. In the present invention, the amount of P as an impurity is preferably as low as possible, but is acceptable up to 0.06%. The amount of P is more preferably 0.01% or less.
S: 0.05% or less

In the steel, S exists as sulfides which deteriorates ductility, workability of the steel products, and corrosion resistance. Accordingly, in the present invention, the amount of S as an impurity is preferably as low as possible, but is acceptable up to 0.05%. The amount of S is more preferably 0.03% or less.

The method for producing the steel products for piston rings of the present invention is not specifically limited, and may be any common method. For example, according to a preferred procedure, the molten steel having the above-described compositions is meld by a common means such as a high frequency induction furnace, and cast into an ingot or the like. And the ingot or the like shaped into bars by a common process such as hot forging or hot rolling, and then the bars are formed into wires in a cold manner, thus producing steel products for piston rings.

The piston rings of the present invention are produced by forming the steel products having the above-described compositions into an intended form. The method for producing the piston rings of the present invention is not specifically limited as long as the above-described steel products are used, and preferably uses a common producing method for forming piston rings into an intended shape.

From the viewpoints of wear resistance and corrosion resistance, it is preferred that the all surfaces or the outer peripheral surface of the piston rings may be subjected to surface treatment thereby forming a surface treating layer. The surface treating layer may be, for example, a nitride layer formed by nitriding, a hard-plated coating layer formed by chrome plating or dispersive plating, a thermal spraying layer formed by thermal spraying, a physical vapor deposition layer formed by physical vapor deposition (PVD), or a chemical vapor deposition layer formed by chemical vapor deposition (CVD). These layers are suitable as the surface treating layers of the piston rings of the present invention. From the viewpoint of wear resistance and opponent aggressivity, the surface treating layer is preferably a nitride layer. The physical vapor deposition layer or chemical vapor deposition layer may be a diamond-like carbon film (DLC film). From the viewpoint of opponent aggressivity, the DLC film is preferably formed on the outer peripheral sliding surface of the surface treating layer. The DLC film strengthens the tendency to lessen the opponent aggressivity. From these facts, it is preferred that, for example, a nitride layer and a DLC film may be formed in this order on the surface of the base material of piston rings.

The hardness of the surface treating layer is preferably from 700 to 1400 HV from the viewpoint of opponent aggressivity. If the hardness is less than 700 HV in terms of Vickers hardness, wear resistance deteriorates. On the other hand, if the hardness of the surface treating layer is more than 1400 HV, compounds are formed to give high opposite aggressivity. In the present invention, from the viewpoint of opponent aggressivity, it is important that the surface treating layer formed on the surface of the piston ring is not so hard thereby preventing the formation of compounds. The hardness of the surface treating layer is preferably from 900 to 1200 HV. When the Vickers hardness is measured, the load is preferably from 100 gf or 200 gf.

The thickness of the surface treating layer is preferably from 1 to 150 μm from the viewpoints of corrosion resistance and adhesion property. The nitriding treatment, hard-plated coating treatment, thermal spraying treatment, physical vapor deposition treatment, and chemical vapor deposition treatment may be carried out by common methods.

### EXAMPLES

### Example 1

The molten steel having any of the composition shown in Table 1 was melted by melting furnace, and was cast into an ingot (12 kg). The ingot was shaped into a round bar having a diameter of 15 mm by hot forging. Subsequently, a mill scale of the round bar was removed and the round bar had a diameter of 12 mm, and the round bar was drawn out into a wire having a diameter of 7 mm. As a prior art example, a wire made of martensitic stainless steel (SUS 410J) was used.

Thermal expansion test pieces each having a diameter of 5 mm and a length 15 mm were taken from the wire, and subjected to thermal expansion test, thereby determining the average thermal expansion coefficient in a temperature range from room temperature (20° C.) to 200° C. The results are shown in Tables 1-1 to 1-4.

TABLE 1

| | | | | | | | | | | Average thermal | |
|---|---|---|---|---|---|---|---|---|---|---|---|
| Wire | Steel | Chemical compositions (% by mass) | | | | | | | | expansion coefficient* | |
| No. | No. | C | Si | Mn | Cr | Ni | Al | N | Nb, Ti, Zr, Mo, Cu | ×10⁻⁶(/° C.) | Note |
| 1 | A | 0.01 | 0.01 | 5.00 | | | | | | 14.0 | Example |
| 2 | B | 1.90 | 1.90 | 24.00 | | | | | | 17.5 | Example |
| 3 | C | 0.004 | 0.20 | 11.00 | | | | | | 13.2 | Comparative Example |
| 4 | D | 1.96 | 0.60 | 14.00 | | | | | | 13.5 | Comparative Example |
| 5 | E | 0.30 | 0.004 | 19.00 | | | | | | 13.7 | Comparative Example |
| 6 | F | 0.40 | 1.98 | 22.00 | | | | | | 12.9 | Comparative Example |
| 7 | G | 0.70 | 1.00 | 4.80 | | | | | | 12.4 | Comparative Example |
| 8 | H | 0.90 | 1.80 | 24.90 | | | | | | 13.1 | Comparative Example |
| 9 | I | 0.20 | 0.40 | 15.00 | 1.00 | | | | | 16.5 | Example |
| 10 | J | 0.50 | 0.90 | 16.00 | 5.00 | | | | | 17.0 | Example |
| 11 | K | 0.80 | 1.20 | 20.00 | 15.00 | | | | | 18.0 | Example |
| 12 | L | 1.00 | 1.70 | 23.00 | 18.00 | | | | | 17.0 | Example |
| 13 | M | 0.05 | 0.05 | 7.00 | | 0.10 | | | | 15.8 | Example |
| 14 | N | 0.08 | 0.09 | 9.00 | | 2.00 | | | | 16.7 | Example |
| 15 | O | 0.10 | 1.10 | 11.00 | | 8.00 | | | | 17.3 | Example |
| 16 | P | 0.20 | 1.60 | 19.00 | | 13.00 | | | | 13.9 | Comparative Example |
| 17 | Q | 0.60 | 0.10 | 12.00 | 14.00 | 0.10 | | | | 16.4 | Example |
| 18 | R | 1.10 | 1.30 | 14.00 | 11.00 | 5.00 | | | | 17.1 | Example |
| 19 | S | 1.80 | 1.80 | 21.00 | 15.00 | 13.00 | | | | 13.3 | Comparative Example |
| 20 | T | 0.01 | 0.01 | 7.00 | | | 0.10 | | | 15.3 | Example |
| 21 | U | 1.90 | 1.90 | 24.00 | | | 0.30 | | | 17.4 | Example |
| 22 | V | 0.004 | 0.20 | 11.00 | | | 0.50 | | | 13.2 | Comparative Example |
| 23 | W | 1.96 | 0.60 | 14.00 | | | 0.60 | | | 13.5 | Comparative Example |
| 24 | X | 0.30 | 0.004 | 19.00 | | | 0.80 | | | 13.7 | Comparative Example |
| 25 | Y | 0.40 | 1.98 | 22.00 | | | 0.70 | | | 12.9 | Comparative Example |

*Average thermal expansion coefficient (RT ~200° C.)

TABLE 2

| | | | | | | | | | | Average thermal | |
|---|---|---|---|---|---|---|---|---|---|---|---|
| Wire | Steel | Chemical compositions (% by mass) | | | | | | | | expansion coefficient* | |
| No. | No. | C | Si | Mn | Cr | Ni | Al | N | Nb, Ti, Zr, Mo, Cu | ×10⁻⁶(/° C.) | Note |
| 26 | 2A | 0.70 | 1.00 | 4.80 | | | 0.90 | | | 13.5 | Comparative Example |
| 27 | 2B | 0.90 | 1.80 | 24.90 | | | 1.00 | | | 13.6 | Comparative Example |
| 28 | 2C | 1.80 | 1.00 | 12.00 | | | 1.10 | | | 13.9 | Comparative Example |
| 29 | 2D | 0.20 | 0.40 | 15.00 | 1.00 | | 0.10 | | | 16.5 | Example |
| 30 | 2E | 0.50 | 0.90 | 16.00 | 5.00 | | 0.20 | | | 17.0 | Example |
| 31 | 2F | 0.80 | 1.20 | 20.00 | 14.00 | | 0.40 | | | 18.0 | Example |
| 32 | 2G | 1.00 | 1.70 | 23.00 | 15.00 | | 0.80 | | | 14.8 | Example |
| 33 | 2H | 0.90 | 0.80 | 18.00 | 11.00 | | 1.10 | | | 13.9 | Comparative Example |
| 34 | 2I | 0.05 | 0.05 | 7.00 | | 0.10 | 0.20 | | | 15.8 | Example |
| 35 | 2J | 0.08 | 0.09 | 9.00 | | 2.00 | 0.40 | | | 16.7 | Example |
| 36 | 2K | 0.10 | 1.10 | 11.00 | | 8.00 | 0.60 | | | 17.3 | Example |
| 37 | 2L | 0.20 | 1.60 | 13.00 | | 13.00 | 0.80 | | | 13.7 | Comparative Example |
| 38 | 2M | 0.60 | 0.30 | 13.00 | | 6.00 | 1.10 | | | 13.7 | Comparative Example |
| 39 | 2N | 0.60 | 0.10 | 12.00 | 18.00 | 0.10 | 0.80 | | | 16.4 | Example |
| 40 | 2O | 1.10 | 1.30 | 14.00 | 11.00 | 5.00 | 0.70 | | | 17.1 | Example |
| 41 | 2P | 1.80 | 1.80 | 21.00 | 15.00 | 13.00 | 0.60 | | | 14.8 | Example |
| 42 | 2Q | 0.30 | 0.15 | 17.00 | 10.00 | 2.00 | 1.10 | | | 13.9 | Comparative Example |
| 43 | 2R | 0.01 | 0.01 | 7.00 | | | | 0.05 | | 15.3 | Example |
| 44 | 2S | 1.90 | 1.90 | 24.00 | | | | 0.10 | | 16.8 | Example |
| 45 | 2T | 0.004 | 0.20 | 11.00 | | | | 0.12 | | 13.2 | Comparative Example |
| 46 | 2U | 1.96 | 0.60 | 14.00 | | | | 0.15 | | 13.7 | Comparative Example |
| 47 | 2V | 0.30 | 0.004 | 19.00 | | | | 0.16 | | 13.7 | Comparative Example |
| 48 | 2W | 0.40 | 1.98 | 22.00 | | | | 0.18 | | 12.9 | Comparative Example |
| 49 | 2X | 0.70 | 1.00 | 4.80 | | | | 0.20 | | 13.5 | Comparative Example |
| 50 | 2Y | 0.90 | 1.80 | 24.90 | | | | 0.30 | | 13.6 | Comparative Example |

*Average thermal expansion coefficient (RT ~200° C.)

TABLE 3

| | | | | | | | | | | | Average thermal | |
|---|---|---|---|---|---|---|---|---|---|---|---|---|
| Wire | Steel | Chemical compositions (% by mass) | | | | | | | | | expansion coefficient* | |
| No. | No. | C | Si | Mn | Cr | Ni | Al | N | Nb, Ti, Zr, Mo, Cu | Total | ×10⁻⁶(/° C.) | Note |
| 51 | 3A | 1.80 | 1.00 | 12.00 | | | | 0.35 | | | 13.9 | Comparative Example |
| 52 | 3B | 0.20 | 0.40 | 15.00 | 1.00 | | | 0.03 | | | 16.5 | Example |
| 53 | 3C | 0.50 | 0.90 | 16.00 | 5.00 | | | 0.06 | | | 17.0 | Example |
| 54 | 3D | 0.80 | 1.20 | 20.00 | 14.00 | | | 0.09 | | | 18.0 | Example |
| 55 | 3E | 1.00 | 1.70 | 23.00 | 15.00 | | | 0.26 | | | 14.6 | Example |
| 56 | 3F | 0.90 | 0.80 | 18.00 | 11.00 | | | 0.40 | | | 13.9 | Comparative Example |
| 57 | 3G | 0.05 | 0.05 | 7.00 | | 0.10 | | 0.15 | | | 15.8 | Example |
| 58 | 3H | 0.08 | 0.09 | 9.00 | | 2.00 | | 0.18 | | | 16.7 | Example |
| 59 | 3I | 0.10 | 1.10 | 11.00 | | 8.00 | | 0.20 | | | 17.3 | Example |
| 60 | 3J | 0.20 | 1.60 | 13.00 | | 13.00 | | 0.29 | | | 13.7 | Comparative Example |
| 61 | 3K | 0.60 | 0.30 | 13.00 | | 6.00 | | 0.40 | | | 13.3 | Comparative Example |
| 62 | 3L | 0.60 | 0.10 | 12.00 | 14.00 | 0.10 | | 0.26 | | | 16.4 | Example |
| 63 | 3M | 1.10 | 1.30 | 14.00 | 11.00 | 5.00 | | 0.28 | | | 17.1 | Example |
| 64 | 3N | 1.80 | 1.80 | 21.00 | 15.00 | 13.00 | | 0.30 | | | 13.7 | Comparative Example |
| 65 | 3O | 0.30 | 0.15 | 17.00 | 10.00 | 2.00 | | 0.40 | | | 13.3 | Comparative Example |
| 66 | 3P | 0.01 | 0.01 | 7.00 | | | | | Cu: 0.10 | 0.10 | 15.7 | Example |
| 67 | 3Q | 1.90 | 1.90 | 24.00 | 5.00 | | 0.50 | | Cu: 3.00 | 3.00 | 16.9 | Example |
| 68 | 3R | 0.80 | 0.20 | 11.00 | 14.00 | 3.00 | | 0.10 | Cu: 5.00 | 5.00 | 13.3 | Comparative Example |
| 69 | 3S | 1.50 | 0.60 | 14.00 | | | | | Mo: 0.10 | 0.10 | 17.1 | Example |
| 70 | 3T | 0.30 | 1.20 | 19.00 | | 8.00 | | 0.10 | Mo: 2.50 | 2.50 | 15.6 | Example |
| 71 | 3U | 0.40 | 1.50 | 22.00 | 5.00 | 9.00 | 0.20 | | Mo: 5.00 | 5.00 | 13.5 | Comparative Example |
| 72 | 3V | 0.70 | 1.00 | 8.80 | 4.00 | | 0.40 | | Nb: 0.10 | 0.10 | 16.8 | Example |
| 73 | 3W | 0.90 | 1.80 | 22.80 | | 5.00 | | 0.20 | Nb: 2.00 | 2.00 | 16.9 | Example |
| 74 | 3X | 0.20 | 0.40 | 15.00 | 1.00 | 3.00 | 0.10 | 0.10 | Nb: 5.00 | 5.00 | 13.5 | Comparative Example |
| 75 | 3Y | 0.50 | 0.90 | 16.00 | 5.00 | | | | Ti: 0.10 | 0.10 | 16.1 | Example |

*Average thermal expansion coefficient (RT ~200° C.)

TABLE 4

| | | | | | | | | | | | Average thermal | |
|---|---|---|---|---|---|---|---|---|---|---|---|---|
| Wire | Steel | Chemical compositions (% by mass) | | | | | | | | | expansion coefficient* | |
| No. | No. | C | Si | Mn | Cr | Ni | Al | N | Nb, Ti, Zr, Mo, Cu | Total | ×10⁻⁶(/° C.) | Note |
| 76 | 4A | 0.80 | 1.20 | 20.00 | 14.00 | 2.00 | 0.10 | | Ti: 2.00 | 2.00 | 16.6 | Example |
| 77 | 4B | 1.00 | 1.70 | 23.00 | 13.00 | 3.00 | | 0.10 | Ti: 5.00 | 5.00 | 13.9 | Comparative Example |
| 78 | 4C | 0.05 | 0.05 | 7.00 | | 0.10 | | | Zr: 0.10 | 0.10 | 15.3 | Example |
| 79 | 4D | 0.08 | 0.09 | 9.00 | 2.00 | 2.00 | | | Zr: 1.00 | 1.00 | 15.7 | Example |
| 80 | 4E | 0.10 | 1.10 | 11.00 | | 8.00 | 0.30 | 0.30 | Zr: 5.00 | 5.00 | 13.9 | Comparative Example |
| 81 | 4F | 0.20 | 1.60 | 13.00 | | | | | Cu: 3.00, Mo: 1.00 | 4.00 | 15.4 | Example |
| 82 | 4G | 0.60 | 0.03 | 14.00 | 3.00 | | 0.20 | | Cu: 2.00, Mo: 2.00 | 4.00 | 15.2 | Example |
| 83 | 4H | 0.90 | 0.06 | 15.00 | | 3.00 | | 0.10 | Cu: 4.00, Mo: 5.00 | 9.00 | 13.5 | Comparative Example |
| 84 | 4I | 0.04 | 0.09 | 16.00 | | 2.00 | | | Cu: 3.50, Nb: 0.50 | 4.00 | 15.1 | Example |
| 85 | 4J | 1.60 | 0.10 | 17.00 | 8.00 | | 0.30 | 0.20 | Cu: 2.00, Nb: 4.50 | 6.50 | 13.4 | Comparative Example |
| 86 | 4K | 1.80 | 0.13 | 18.00 | | 1.00 | 0.40 | | Cu: 2.50, Ti: 1.50 | 4.00 | 17.7 | Example |
| 87 | 4L | 0.30 | 0.18 | 19.00 | 11.00 | | | | Cu: 3.50, Ti: 4.20 | 7.70 | 13.2 | Comparative Example |
| 88 | 4M | 0.10 | 0.20 | 20.00 | | 3.00 | | | Cu: 3.50, Zr: 0.50 | 4.00 | 16.0 | Example |
| 89 | 4N | 0.65 | 0.40 | 0.35 | 13.5 | | | | Mo: 0.3 | 0.30 | 13.5 | Prior art Example |

The examples of the present invention had a thermal expansion coefficient of 14.0×10⁻⁶/° C. or higher, indicating that they stably ensure to have a thermal expansion coefficient close to that of aluminium alloys. The piston rings made of the steel products of the present invention likely provide a sufficient sealing property when processed into piston rings sliding on aluminum alloy cylinders as an opposite material. On the other hand, the comparative examples out of the scope of the present invention have thermal expansion coefficients of less than 14.0×10⁻⁶/° C., arising concern that they may have an insufficient sealing property, increase blow by gas, and deteriorate other properties.

### Example 2

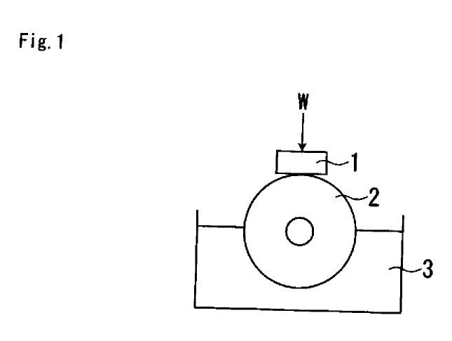

Piston ring equivalent materials in a given size and shape were made from the wires No. 14, 75, 89, and 90 listed in Table 1, and measured for the wear resistance using the Amsler's wear testing machine schematically illustrated in FIG. 1. As the surface treating layers of the piston ring equivalent materials, a laminated hard-plated coating layer, a single nitride layer, and a nitride layer coated with a DLC film were formed in the thicknesses listed in Table 2. The laminated hard-plated coating layer was formed in accordance with the method described in Japanese Patent Application Laid-Open No. 2003-221695. The nitride layer was formed by heating at 550° C. for 5 hours in an atmosphere of ammonia decomposition gas, and then treating final treatment. The thickness of the nitride layer was about 100 μm.

The DLC film was formed by decomposing a C₂H₂ gas by a CVD process, and a target containing W and Ni was evaporated by sputtering.

The surface treating layer was formed on the sliding surface or the all surfaces. The hardness of the surface treating layer was measured at the surface treating layers of the test pieces taken from the piston ring equivalent materials, using a Vickers hardness meter (test force: 1.96N, load: 200 gf).

The prior art example No. 89 is made of an SUS 410J wire.

The surface roughness of the piston ring equivalent materials was from 0.85 to 0.95 (μm) in terms of Rz defined in JIS B 0601 (1994), and from 0.06 to 0.15 (μm) in terms of Rpk defined in DIN 4776.

The wear resistance test was carried out using the Amsler's wear testing machine schematically illustrated in FIG. 1. In the wear resistance test, a test material 1 was pressed against a rotating opposite material 2 under a predetermined load w for a predetermined time. The reference numeral 3 indicates a lubricant. The opposite material 2 is a cylinder liner equivalent material having a surface roughness of 0.70 to 0.88 (μm) in terms of Rz defined in JIS B 0601 (1994), 0.20 to 0.38 (μm) in terms of Rk defined in DIN 4776, 0.05 to 0.10 (μm) in terms of Rpk, and 0.08 to 0.2 (μm) in terms of Rvk, made of a hyper-eutectic aluminum-silicon-type material composed of 24.0% of Si, 0.8% of Mg, 3.0% of Cu, 0.15% of Fe, and 0.01% of Ni, and residual Al. The test conditions are as follows.

Opposite material rotation speed: 1 m/s

Load: 784 N

Lubricant: turbine oil

Test time: 8 hours

Oil temperature: 80° C.

After the test, the wear losses (μm) of the test material (piston ring equivalent material) and the opposite material (cylinder liner equivalent material) were measured, and the evaluation of the wear resistance was evaluated.

The results are shown in Table 2.

TABLE 5

| | | | | | | Wear loss | | |
|---|---|---|---|---|---|---|---|---|
| | | Surface treating layer | | | Surface treating layer: | (μm) | | |
| Wire | Steel | | Thickness | Hardness: | Location of surface | Test | Opposite | |
| No. | No. | : Type | (μm) | HV | treating layer | material | material | Note |
| 14 | N | Laminated Cr plated | 150 | 1150 | Sliding surface | 1 | 0.5 | Example |
| | | layer | | | | | | |
| 75 | 3Y | Gas nitride layer | 90 | 1200 | All surfaces | 1 | 0.5 | Example |
| 89 | 4N | Gas nitride layer | 100 | 1150 | All surfaces | 1.7 | 0.7 | Prior art Example |
| 75 | 3Y | Gas nitride layer + | nitride layer: 90, | DLC: 1800 | All surfaces + outer | 0.8 | 0.4 | Example |
| | | DLC film | DLC: 5 | | peripheral sliding surface | | | |

The examples of the present invention exhibited markedly higher wear resistance than the comparative example made of martensitic stainless steel (wire No. 89). The hardness of the surface treating layers of the examples of the present invention was about 1100 to 1200 HV.

Although scuffing resistance is not evaluated in Table 2, it is needless to say that the examples of the present invention have satisfactory scaff resistance because they have the same surface treating layers as prior art.

### INDUSTRIAL APPLICABILITY

The present invention allows easy and cost-effective manufacture of piston rings for internal combustion engines which sufficiently conform to the thermal expansion of aluminum alloy cylinders and have a good sealing property, thus achieving remarkable industrial effects. In addition, according to the present invention, blow by gas is reduced, and good wear resistance is achieved.

1. A steel product for piston rings sliding on the inside surface of aluminum alloy cylinder bores, where in the steel product for internal combustion engine piston rings comprising 0.01 to 1.9% of C, 0.01 to 1.9% of Si, and 5.0 to 24.0% of Mn in terms of mass, the remainder being composed of Fe and unavoidable impurities.

2. The steel product for internal combustion engine piston rings according to claim 1, which further comprises 18.0% or less of Cr and/or 12.0% or less of Ni in terms of mass.

3. The steel product for internal combustion engine piston rings according to claim 1, which further comprises 1% or less of Al in terms of mass.

4. The steel product for internal combustion engine piston rings according to claim 1, which further comprises 0.3% or less of N in terms of mass.

5. The steel product for internal combustion engine piston rings according to claim 1, which further comprises one or more elements selected from the group consisting of Nb, Ti, Zr, Mo, and Cu in the total amount of 4.0% or less in terms of mass.

6. Piston rings used in an internal combustion engine having an aluminum alloy cylinder block, where of the internal combustion engine piston rings are made of the steel product for piston rings according to claim 1.

7. The internal combustion engine piston rings according to claim 6, which have a surface treating layer on the all surfaces or the outer peripheral surface of the piston rings.

8. The internal combustion engine piston rings according to claim 7, wherein the surface treating layer has a Vickers hardness of 700 to 1400 HV.

9. The internal combustion engine piston rings according to claim 7, wherein the surface treating layer is a nitride layer.

10. The internal combustion engine piston rings according to claim 7, which comprise a diamond-like carbon film on the outer peripheral sliding surface of the surface treating layer.

11. The steel product for internal combustion engine piston rings according to claim 2, which further comprises 1% or less of Al in terms of mass.

12. The steel product for internal combustion engine piston rings according to claim 2, which further comprises 0.3% or less of N in terms of mass.

13. The steel product for internal combustion engine piston rings according to claim 3, which further comprises 0.3% or less of N in terms of mass.

14. The steel product for internal combustion engine piston rings according to claim 2, which further comprises one or more elements selected from the group consisting of Nb, Ti, Zr, Mo, and Cu in the total amount of 4.0% or less in terms of mass.

15. The steel product for internal combustion engine piston rings according to claim 3, which further comprises one or more elements selected from the group consisting of Nb, Ti, Zr, Mo, and Cu in the total amount of 4.0% or less in terms of mass.

16. The steel product for internal combustion engine piston rings according to claim 4, which further comprises one or more elements selected from the group consisting of Nb, Ti, Zr, Mo, and Cu in the total amount of 4.0% or less in terms of mass.

17. Piston rings used in an internal combustion engine having an aluminum alloy cylinder block, where of the internal combustion engine piston rings are made of the steel product for piston rings according to claim 2.

18. Piston rings used in an internal combustion engine having an aluminum alloy cylinder block, where of the internal combustion engine piston rings are made of the steel product for piston rings according to claim 3.

19. Piston rings used in an internal combustion engine having an aluminum alloy cylinder block, where of the internal combustion engine piston rings are made of the steel product for piston rings according to claim 4.

20. Piston rings used in an internal combustion engine having an aluminum alloy cylinder block, where of the internal combustion engine piston rings are made of the steel product for piston rings according to claim 5.
